(19) United States
(12) Patent Application Publication
(10) Pub. No.: US 2018/0105451 A1
(43) Pub. Date: Apr. 19, 2018

(54) CREATION OF HOLES AND SLOTS IN GLASS SUBSTRATES

(71) Applicant: Corning Incorporated, Corning, NY (US)

(72) Inventor: Kristopher Allen Wieland, Painted Post, NY (US)

(21) Appl. No.: 15/782,946

(22) Filed: Oct. 13, 2017

Related U.S. Application Data
(60) Provisional application No. 62/407,900, filed on Oct. 13, 2016.

(51) Int. Cl. C03B 33/02; B23K 26/00; B23K 26/04; B23K 26/046; B23K 26/06; B23K 26/082; B23K 26/382; B23K 26/38

(52) U.S. Cl. CPC C03B 33/0222; B23K 26/0087; B23K 26/043; B23K 26/38; B23K 26/0626; B23K 26/082; B23K 26/382; B23K 26/046

(57) ABSTRACT

The present invention relates to a process for cutting and separating interior contours in thin substrates of transparent materials, in particular glass. The method involves the utilization of an ultra-short pulse laser to form perforation or holes in the strengthened (e.g., ion exchanged) glass substrate, that may be followed by use of another, focused, laser beam to promote full separation about the perforated line.

This application claims the benefit of priority under 35 U.S.C. § 119 of U.S. Provisional Application Ser. No. 62/407,900 filed on Oct. 13, 2016, the content of which is relied upon and incorporated herein by reference in its entirety.

### BACKGROUND

The cutting of holes and slots in thin substrates of transparent materials, such as glass, can be accomplished by focused laser beams that are used to ablate material along the contour of a hole or slot, where multiple passes are used to remove layer after layer of material until the inner plug no longer is attached to the outer substrate piece. The problem with such processes is that they generate significant ablative debris which will contaminate the surfaces of the part a lot of subsurface damage (>100 μm) along the edge of the contour.

Therefore, there is a need for an improved process for cutting holes and slots.

### SUMMARY

Embodiments described herein relate to a process for cutting and separating interior contours in thin substrates of transparent materials, in particular glass.

In one embodiment a method of forming a glass article, comprises:

I. focusing a pulsed first laser beam into a laser beam focal line;

II. directing the laser beam focal line into an ion exchanged glass substrate at a plurality of locations along a closed inner contour defining an inner glass piece, the laser beam focal line generating an induced absorption within the ion exchanged glass substrate such that the laser beam focal line produces a defect line extending through a thickness of the ion exchanged glass substrate at each location of the plurality of locations;

III. directing another focused laser beam into at least a portion of the inner glass piece and ablating at least the least a portion of the inner glass piece.

According to some embodiments the ion exchanged glass substrate is a chemically strengthened glass substrate. According to some embodiments the ion exchanged glass substrate is situated at least partially over display glass. According to some embodiments the focal line does not generate induced absorption within the display glass. According to some embodiments the ion exchanged glass substrate is situated at least partially over a display glass and at least partially over at least one electronic component, the method further comprising a step of removing of the inner glass piece from the ion exchanged glass substrate, without damaging the cover glass or the electronic component.

In at least some embodiments, the ion exchanged glass substrate is a cover glass mounted in a consumer electronic device. In some embodiments the ion exchanged glass substrate is situated over an electronic component of the consumer electronic device. In some embodiments the ion exchanged glass substrate is situated over an electronic component of the consumer electronic device and the pulsed first laser beam has a wavelength that is transparent to the ion exchanged glass substrate but not to the electronic component. the ion exchanged glass substrate is situated over an electronic component of the consumer electronic device and the pulsed first laser beam has a wavelength that is transparent to the ion exchanged glass substrate but not to the electronic component. In some embodiments the consumer electronic device is or comprises a display device. In some embodiments the ion exchanged glass substrate is situated over an electronic component of the display device. In some embodiments the ion exchanged glass substrate is situated over an electronic component of the display device and the pulsed first laser beam has a wavelength that is transparent to the ion exchanged glass substrate but not to the electronic component. The ion exchanged glass substrate is situated over an electronic component of the display device and the pulsed first laser beam has a wavelength that is transparent to the ion exchanged glass substrate but not to the electronic component.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of exemplary parts to be cut out of a starting glass sheet utilized in an exemplary consumer device. The exemplary part may have both outer and inner contours. The outer contour can be easily released from the starting (mother) sheet by adding in additional cuts or “release lines.”

FIGS. 2A and 2B are illustrations of positioning of the laser beam focal line, i.e., the processing of a material transparent for the laser wavelength due to the induced absorption along the focal line.

FIG. 3A is an illustration of an optical assembly for laser drilling.

FIG. 3B-1 thru 3B-4 is an illustration of various possibilities to process the substrate by differently positioning the laser beam focal line relative to the substrate.

FIG. 4 is an illustration of a second optical assembly for laser drilling.

FIGS. 5A and 5B are illustrations of a third optical assembly for laser drilling.

FIG. 6 is a schematic illustration of a fourth optical assembly for laser drilling.

FIG. 7A-7C is an illustration of different regimes for laser processing of materials. FIG. 7A illustrates an unfocused laser beam, FIG. 7B illustrates a condensed laser beam with a spherical lens, and FIG. 7C illustrates a condensed laser beam with an axicon or diffractive Fresnel lens.

FIG. 8A illustrates schematically the relative intensity of laser pulses within an exemplary pulse burst vs. time, with each exemplary pulse burst having 3 pulses.

FIG. 8B illustrates schematically relative intensity of laser pulses vs. time within an exemplary pulse burst, with each exemplary pulse burst containing 5 pulses.

FIG. 8C is a description of different laser steps and paths traced out to define an inner contour and remove the material inside this contour.

FIG. 9 is a description of the CO₂ laser step for removal of the material inside the contour.

FIG. 10 is an example (microscope image) of a hole formation.

FIGS. 11A-11C are illustrations of a fault line (or perforated line) with equally spaced defect lines or damage tracks of modified glass.

### DETAILED DESCRIPTION

A description of example embodiments follows.

Disclosed herein is a process for cutting and separating interior contours in thin substrates of transparent materials, in particular glass. The glass may be, for example, ion exchanged glass sheet mounted in a consumer electronic device. An example of such consumer electronic device is a cell phone (e.g., a “smart” phone), or tablet. The method involves the utilization of an ultra-short pulse laser to form perforation or holes in the substrate. The laser process described below generates full body cuts of a variety of glasses in a single pass, with low sub-surface damage (<75 um), and excellent surface roughness (Ra<0.5 um). Sub-surface damage (SSD) is defined as the extent of cracks or “checks” perpendicular to the cut edge of the glass piece. The magnitude of the distance these cracks extend into the glass piece can determine the amount of later material removal that may be needed from grinding and polishing operations that are used to improve glass edge strength. SSD may be measured by using confocal microscope to observed light scattering from the cracks, and determining the maximum distance the cracks extend into the body of the glass over a given cut edge.

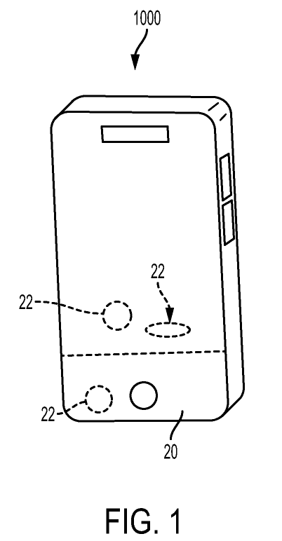

One embodiment relates a method to cut and separate interior contours in materials such as glass, with a separation process that exposes the high quality edge generated by the above-mentioned perforation process without damaging it by the separation process. When a part 22 is cut out of a substrate, it may be comprised of inner contours, as shown (by dashed lines) in FIG. 1. In some cases, for the highly stressed materials and large enough interior contours, the inner part may self-separate and fall out. However, for small holes and slots (e.g., 10 mm holes, slots of widths <few mm, for example: ≤mm, or ≤2 mm, or even ≤1 mm), even for stressed materials, the inner part will not fall out. A hole 22 is generally defined as a circular or substantially circular feature in cross-section. In contrast, slots 22 are generally have highly elliptical features, such as features that have aspect ratios (e.g., cross-sectional or as viewed from the top or bottom, for example) of length to width of >4:1, typically 25:1, for example 1.5 mm×15 mm, or 3 mm×15 mm, or 1 mm×10 mm, or 1.5 mm by 7 mm, etc. Slots may have radiused corners, or the corners may be sharp (90 degree) features.

The challenge with separating an interior contour, such as a hole or a slot in a glass piece such as in cover glass of smart phone, is that even if the contour is well perforated and a crack propagates around it, the inner plug of material may be under compressive pressure and locked in place by the material surrounding the plug. This means that the challenging part is an automated release process that allows the plug to drop out.

The present application is generally directed to a laser method and apparatus for precision cutting and separation of arbitrary shapes out of glass substrates that constitute a part of a consumer electronic device, where the glass substrate is situated over one or more of underlying components. The precision cutting and is performed in a controllable fashion, with minimum (or insignificant) thermal damage to the underlying components of the device. The developed laser method relies on the material transparency of the glass to the laser wavelength in linear regime which allows maintenance of a clean and pristine surface quality and reduced subsurface damage created by the area of high intensity around the laser focus. One of the key enablers of this process is the high aspect ratio of the defect created by the ultra-short pulsed laser. It allows creation of a fault line that extends from the top to the bottom surfaces of the material to be cut. In principle, this defect can be created by a single laser pulse and if necessary, additional pulses can be used to increase the extension of the affected area (depth and width).

Using a short pulse picosecond laser and optics which generate a focal line, a closed contour is perforated in a glass sheet. The perforations are less than a few microns in diameter, typical spacing of the perforations is 1-15 μm, and the perforations go entirely through the glass sheet.

A focused laser beam (e.g., CO₂ laser beam) of a high enough power density to ablate the glass material is then traced around the interior of the perforated contour, creating a trench (e.g., 200-800 micron wide) to facilitate of the removal of the interior glass material (i.e., removal of the of the glass plug). One or more passes of the laser may be used. This process may be spread out in time to minimize the thermal damage to the underlying components.

The method to cut and separate transparent materials is essentially based on creating a fault line on the material to be processed with an ultra-short pulsed laser. Depending on the material properties (absorption, CTE, stress, composition, etc.) and laser parameters chosen for processing that determined material.

However, even if the glass has enough internal stress to start self-separation after the formation of the defect line, the geometry of the cut contour may prevent an interior glass part (plug) from moving relative to the outer glass part. This is the case for most closed or inner contours within the glass substrate such as simple holes or slots 22. The interior portion of the aperture, because of the intimate contact with the edges will remain in place—the cracks may propagate between the perforated defects, but no room exists to allow the piece to fall out of the mother sheet.

### Forming the Defect or Perforation Line

For the first process step, there are several methods to create that defect line. The optical method of forming the line focus can take multiple forms, using donut shaped laser beams and spherical lenses, axicon lenses, diffractive elements, or other methods to form the linear region of high intensity. The type of laser (picosecond, femtosecond, etc.) and wavelength (IR, green, UV, etc.) can also be varied, as long as sufficient optical intensities are reached to create breakdown of the substrate material. This wavelength may be, for example, 1064 nm, 532, nm, 355 nm or 266 nanometers.

Ultra-short pulse lasers can be used in combination with optics that generate a focal line to fully perforate the body of a range of glass compositions. In some embodiments, the pulse duration of the individual pulses is in a range of between greater than about 1 picoseconds and less than about 100 picoseconds, such as greater than about 5 picoseconds and less than about 20 picoseconds, and the repetition rate of the individual pulses can be in a range of between about 1 kHz and 4 MHz, such as in a range of between about 10 kHz and 650 kHz.

In addition to a single pulse operation at the aforementioned individual pulse repetition rates, the pulses can be produced in bursts of two pulses, or more (such as, for example, 3 pulses, 4, pulses, 5 pulses, 10 pulses, 15 pulses, 20 pulses, or more) separated by a duration between the individual pulses within the pulse burst that is in a range of between about 1 nsec and about 50 nsec, for example, 10-50 nsec, or 10 to 30 nsec, such as about 20 nsec, and the burst repetition frequency can be in a range of between about 1 kHz and about 200 kHz (bursting or producing pulse bursts is a type of laser operation where the emission of pulses is not in a uniform and steady stream but rather in tight clusters of pulses). The pulse burst laser beam can have a wavelength selected such that the material is substantially transparent at this wavelength. The average laser power per burst measured at the material can be greater than 40 microJoules per mm thickness of material, for example between 40 microJoules/mm and 2500 microJoules/mm, or between 200 and 800 microJoules/mm. For example, for 0.5 mm-0.7 mm thick ion exchanged glass one may use 150-300 (e.g., 200 μJ) pulse bursts perforate the glass, which gives an exemplary range of 100-400 μJ/mm. The glass is moved relative to the laser beam (or the laser beam is translated relative to the glass) to create perforated lines that trace out the shape of any desired parts.

The laser creates hole-like defect zones (or damage tracks, or defect lines) that penetrate the full depth the glass, with internal openings, for example of approximately 1 micron in diameter. These perforations, defect regions, damage tracks, or defect lines are generally spaced from 1 to 15 microns apart (for example, 2-12 microns, or 3-10 microns). The defect lines extend, for example, through the thickness of the glass sheet, and are orthogonal to the major (flat) surfaces of the glass sheet.

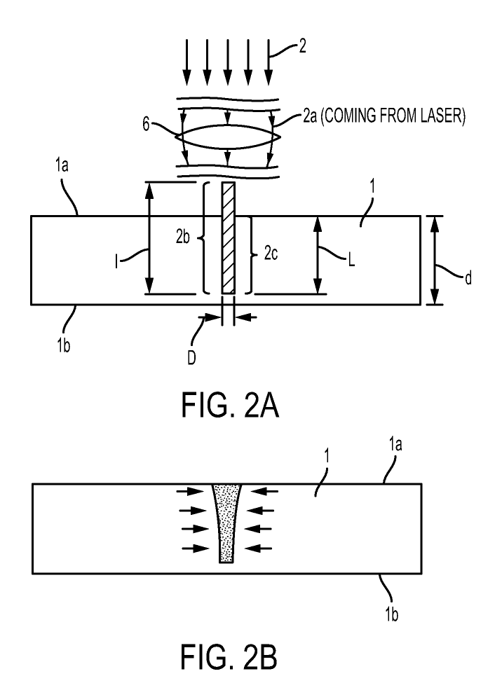

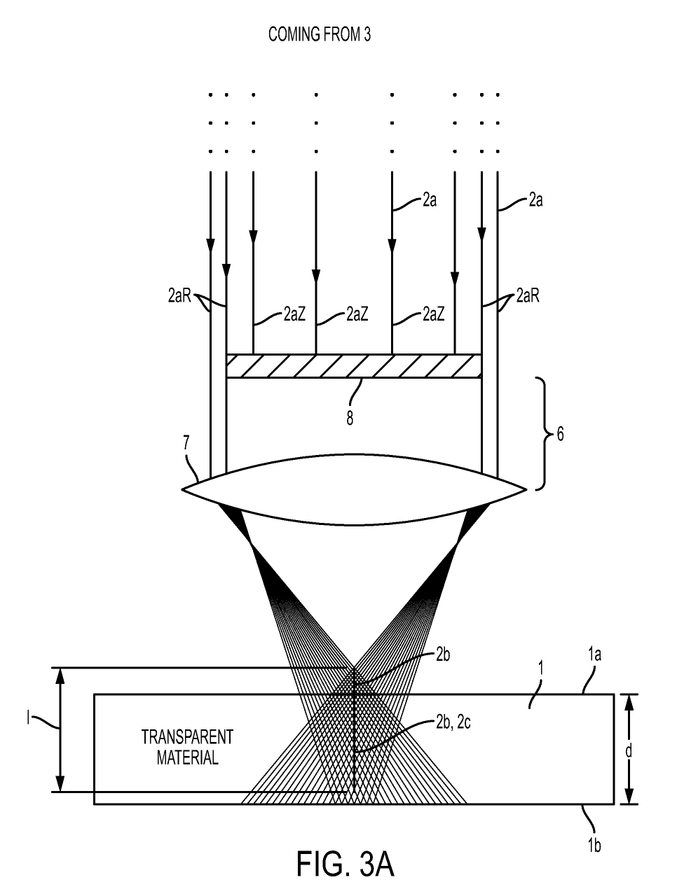

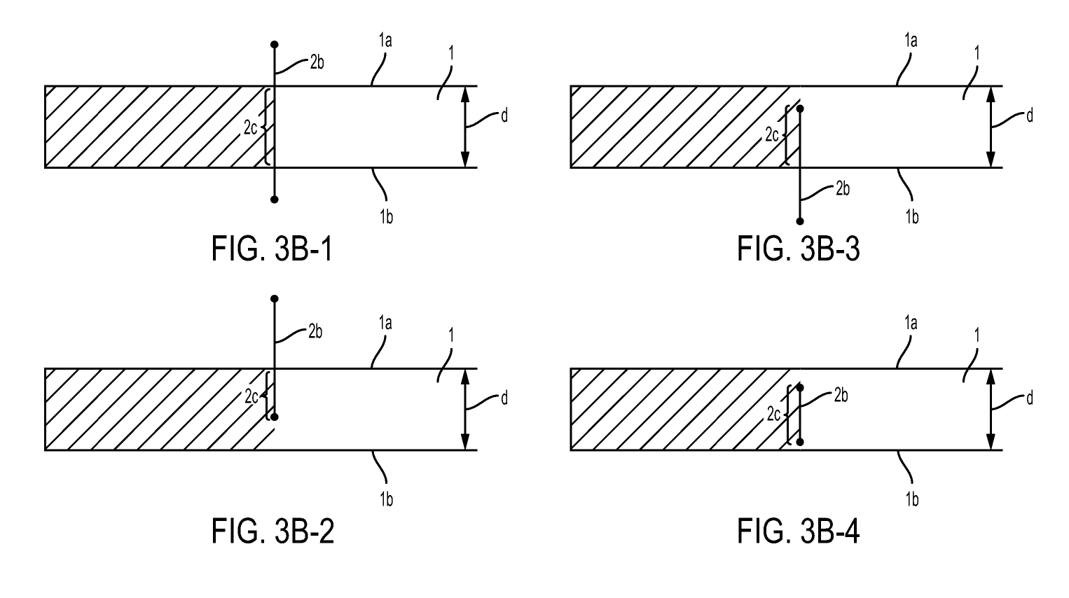

In one embodiment, an ultra-short (˜10 μsec) burst pulsed laser is used to create this high aspect ratio vertical defect line in a consistent, controllable and repeatable manner. The detail of the optical setup that enables the creation of this vertical defect line is described below and in U.S. Application No. 61/752,489, filed on Jan. 15, 2013. The essence of this concept is to use an axicon lens element in an optical lens assembly to create a region of high aspect ratio taper-free microchannel using ultra-short (picoseconds or femtosecond duration) Bessel beams. In other words, the axicon condenses the laser beam into a region of cylindrical shape and high aspect ratio (long length and small diameter). Due to the high intensity created with the condensed laser beam, nonlinear interaction of the laser electromagnetic field and the material occurs and the laser energy is transferred to the substrate. However, it is important to realize that in the areas where the laser energy intensity is not high (e.g., glass surface, or glass volume surrounding the central convergence line, or below any region situated below the glass where any underlying material scatters the laser energy) nothing happens to the glass, as the laser intensity is below the nonlinear threshold. Thus, according to at least some of the embodiments disclosed herein the laser intensity of the Bessel bam(s) is lower than the linear or non-linear damage (or ablation) threshold of the electronic (and/or other components of the consumer electronic device) that are situated directly under the glass substrate portion that is being processed by Bessel beam(s). This can be achieved, for example, by having electrical components or their housing containing a painted surface that is absorbs at least 80% of light in the wavelength(s) of the Bessel beam(s). Turning to FIGS. 2A and 2B, a method of laser drilling a material includes focusing a pulsed laser beam 2 into a laser beam focal line 2b, viewed along the beam propagation direction. As shown in FIG. 3, laser 3 (not shown) emits laser beam 2, at the beam incidence side of the optical assembly 6 referred to as 2a, which is incident on the optical assembly 6. The optical assembly 6 turns the incident laser beam into an extensive laser beam focal line 2b on the output side over a defined expansion range along the beam direction (length l of the focal line). The planar substrate 1 to be processed is positioned in the beam path after the optical assembly overlapping at least partially the laser beam focal line 2b of laser beam 2. Reference 1a designates the surface of the planar substrate facing the optical assembly 6 or the laser, respectively, reference 1b designates the reverse surface of substrate 1 usually spaced in parallel. The substrate thickness (measured perpendicularly to the planes 1a and 1b, i.e., to the substrate plane) is labeled with d.

As FIG. 2A depicts, substrate 1 is aligned perpendicularly to the longitudinal beam axis and thus behind the same focal line 2b produced by the optical assembly 6 (the substrate is perpendicular to the drawing plane) and viewed along the beam direction it is positioned relative to the focal line 2b in such a way that the focal line 2b viewed in beam direction starts before the surface 1a of the substrate and stops before the surface 1b of the substrate, i.e. still within the substrate. In the overlapping area of the laser beam focal line 2b with substrate 1, i.e. in the substrate material covered by focal line 2b, the extensive laser beam focal line 2b thus generates (in case of a suitable laser intensity along the laser beam focal line 2 b which is ensured due to the focusing of laser beam 2 on a section of length l, i.e. a line focus of length l) an extensive section 2c viewed along the longitudinal beam direction, along which an induced absorption is generated in the substrate material which induces a defect line or crack formation in the substrate material along section 2c. The crack formation is not only local, but over the entire length of the extensive section 2c of the induced absorption. The length of section 2c (i.e., after all, the length of the overlapping of laser beam focal line 2b with substrate 1) is labeled with reference L. The average diameter or the average extension of the section of the induced absorption (or the sections in the material of substrate 1 undergoing the crack formation) is labeled with reference D. This average extension D basically corresponds to the average diameter o of the laser beam focal line 2b, that is, an average spot diameter in a range of between about 0.1 μm and about 5 μm.

As FIG. 2A shows substrate material transparent for the wavelength A of laser beam 2 is heated due to the induced absorption along the focal line 2b. FIG. 2B outlines that the warming material will eventually expand so that a correspondingly induced tension leads to micro-crack formation, with the tension being the highest at surface 1a.

Concrete optical assemblies 6, which can be applied to generate the focal line 2b, as well as a concrete optical setup, in which these optical assemblies can be applied, are described below. All assemblies or setups are based on the description above so that identical references are used for identical components or features or those which are equal in their function. Therefore only the differences are described below.

As the parting face eventually resulting in the separation is or must be of high quality (regarding breaking strength, geometric precision, roughness and avoidance of re-machining requirements), the individual focal lines to be positioned on the substrate surface along parting line 5 should be generated using the optical assembly described below (hereinafter, the optical assembly is alternatively also referred to as laser optics). The roughness results particularly from the spot size or the spot diameter of the focal line. In order to achieve a low spot size of, for example, 0.5 μm to 2 μm in case of a given wavelength A of laser 3 (interaction with the material of substrate 1), certain requirements must usually be imposed on the numerical aperture of laser optics 6. These requirements are met by laser optics 6 described below.

In order to achieve the required numerical aperture, the optics must, on the one hand, dispose of the required opening for a given focal length, according to the known Abbé formulae (N.A.=n sin (theta), where n is the refractive index of the glass to be processed, theta is the half the aperture angle; and theta=arctan (D/2f); D is the aperture, and f is the focal length). On the other hand, the laser beam must illuminate the optics up to the required aperture, which is typically achieved by means of beam widening using widening telescopes between laser and focusing optics.

The spot size should not vary too strongly for the purpose of a uniform interaction along the focal line. This can, for example, be ensured (see the embodiment below) by illuminating the focusing optics only in a small, circular area so that the beam opening and thus the percentage of the numerical aperture only vary slightly.

According to FIG. 3A (section perpendicular to the substrate plane at the level of the central beam in the laser beam bundle of laser radiation 2; here, too, the center of the laser beam 2 is preferably perpendicularly incident to the substrate plane, i.e. angle is 0° so that the focal line 2b or the extensive section of the induced absorption 2c is parallel to the substrate normal), the laser radiation 2a emitted by laser 3 is first directed onto a circular aperture 8 which is completely opaque for the laser radiation used. Aperture 8 is oriented perpendicular to the longitudinal beam axis and is centered on the central beam of the depicted beam bundle 2a. The diameter of aperture 8 is selected in such a way that the beam bundles near the center of beam bundle 2a or the central beam (here labeled with 2aZ) hit the aperture and are completely absorbed by it. Only the beams in the outer perimeter range of beam bundle 2a (marginal rays, here labeled with 2aR) are not absorbed due to the reduced aperture size compared to the beam diameter, but pass aperture 8 laterally and hit the marginal areas of the focusing optic elements of the optical assembly 6, which is designed as a spherically cut, bi-convex lens 7 here.

Lens 7 centered on the central beam is deliberately designed as a non-corrected, bi-convex focusing lens in the form of a common, spherically cut lens. Put another way, the spherical aberration of such a lens is deliberately used. As an alternative, aspheres or multi-lens systems deviating from ideally corrected systems, which do not form an ideal focal point but a distinct, elongated focal line of a defined length, can also be used (i.e., lenses or systems which do not have a single focal point). The zones of the lens thus focus along a focal line 2b, subject to the distance from the lens center. The diameter of aperture 8 across the beam direction is approximately 90% of the diameter of the beam bundle (beam bundle diameter defined by the extension to the decrease to 1/e²) (intensity) and approximately 75% of the diameter of the lens of the optical assembly 6. The focal line 2b of a non-aberration-corrected spherical lens 7 generated by blocking out the beam bundles in the center is thus used. FIG. 3A shows the section in one plane through the central beam, the complete three-dimensional bundle can be seen when the depicted beams are rotated around the focal line 2b.

One disadvantage of this focal line is that the conditions (spot size, laser intensity) along the focal line, and thus along the desired depth in the material, vary and therefore the desired type of interaction (no melting, induced absorption, thermal-plastic deformation up to crack formation) may possibly only be selected in a part of the focal line. This means in turn that possibly only a part of the incident laser light is absorbed in the desired way. In this way, the efficiency of the process (required average laser power for the desired separation speed) is impaired on the one hand, and on the other hand the laser light might be transmitted into undesired deeper places (parts or layers adherent to the substrate or the substrate holding fixture) and interact there in an undesirable way (heating, diffusion, absorption, unwanted modification).

FIG. 3B-1-4 show (not only for the optical assembly in FIG. 3A, but basically also for any other applicable optical assembly 6) that the laser beam focal line 2b can be positioned differently by suitably positioning and/or aligning the optical assembly 6 relative to substrate 1 as well as by suitably selecting the parameters of the optical assembly 6: As FIG. 3B-1 outlines, the length l of the focal line 2b can be adjusted in such a way that it exceeds the substrate thickness d (here by factor 2). If substrate 1 is placed (viewed in longitudinal beam direction) centrally to focal line 2b, an extensive section of induced absorption 2c is generated over the entire substrate thickness.

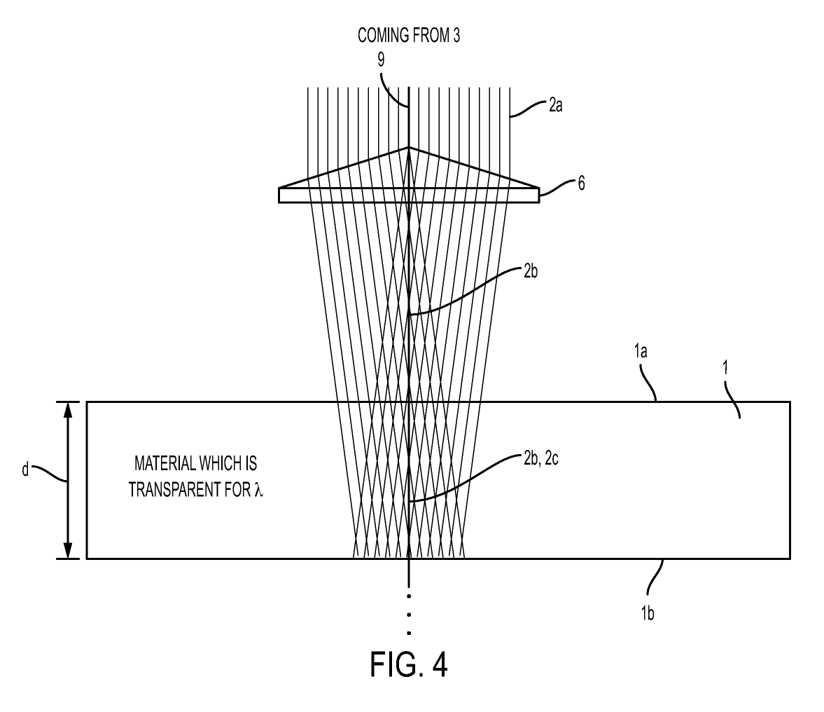

In the case shown in FIG. 3B-2, a focal line 2b is generated which has a length l which is substantially the same as the substrate thickness d. As substrate 1 relative to line 2 is positioned in such a way that line 2b starts in a point before, i.e. outside the substrate, the length L of the extensive section of induced absorption 2c (which extends here from the substrate surface to a defined substrate depth, but not to the reverse surface 1b) is smaller than the length l of focal line 2b. FIG. 3B-3 shows the case in which the substrate 1 (viewed along the beam direction) is partially positioned before the starting point of focal line 2b so that, here too, it applies to the length l of line 2b l>L (L=extension of the section of induced absorption 2c in substrate 1). The focal line thus starts within the substrate and extends over the reverse surface 1b to beyond the substrate. FIG. 3B-4 finally shows the case in which the generate focal line length l is smaller than the substrate thickness d so that—in case of a central positioning of the substrate relative to the focal line viewed in the direction of incidence—the focal line starts near the surface 1a within the substrate and ends near the surface 1b within the substrate (1=0.75 d).

It is particularly advantageous to realize the focal line positioning in such a way that at least one surface 1a, 1b is covered by the focal line, i.e. that the section of induced absorption 2c starts at least on one surface. In this way it is possible to achieve virtually ideal cuts avoiding feathering and unwanted particulation at the surface.

FIG. 4 depicts another applicable optical assembly 6. The basic construction follows the one described in FIG. 3A so that only the differences are described below. The depicted optical assembly is based upon the use of optics with a non-spherical free surface in order to generate the focal line 2b, which is shaped in such a way that a focal line of defined length l is formed. For this purpose, aspheres can be used as optic elements of the optical assembly 6. In FIG. 4, for example, a so-called conical prism, also often referred to as axicon, is used. An axicon is a special, conically cut lens which forms a spot source on a line along the optical axis (or transforms a laser beam into a ring). The layout of such an axicon is principally known to one of skill in the art; the cone angle in the example is 10°. The apex of the axicon labeled here with reference 9 is directed towards the incidence direction and centered on the beam center. As the focal line 2b of the axicon 9 already starts in its interior, substrate 1 (here aligned perpendicularly to the main beam axis) can be positioned in the beam path directly behind axicon 9. As FIG. 4 shows, it is also possible to shift substrate 1 along the beam direction due to the optical characteristics of the axicon without leaving the range of focal line 2b. The extensive section of the induced absorption 2c in the material of substrate 1 therefore extends over the entire substrate thickness d.

However, the depicted layout is subject to the following restrictions: As the focal line of axicon 9 already starts within the lens, a significant part of the laser energy is not focused into part 2c of focal line 2b, which is located within the material, in case of a finite distance between lens and material. Furthermore, length l of focal line 2b is related to the beam diameter for the available refraction indices and cone angles of axicon 9, which is why, in case of relatively thin materials (several millimeters), the total focal line is too long, having the effect that the laser energy is again not specifically focused into the material.

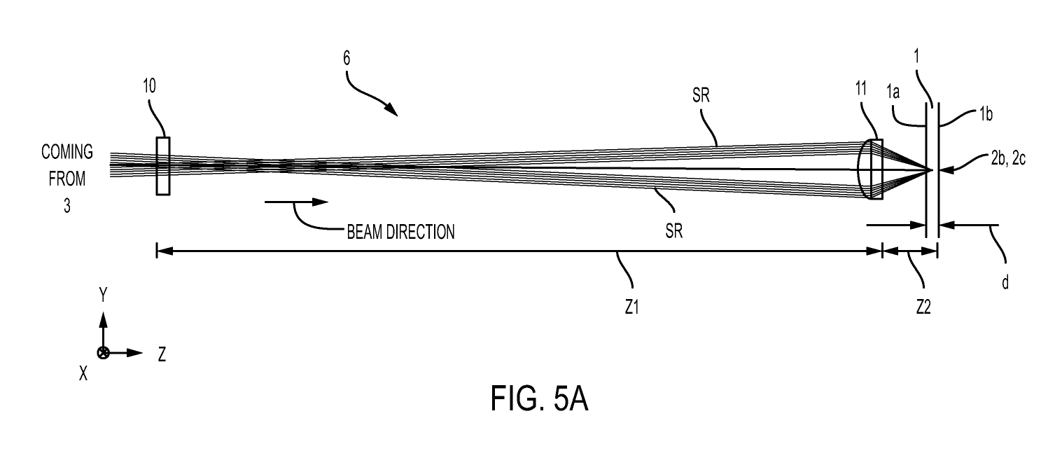

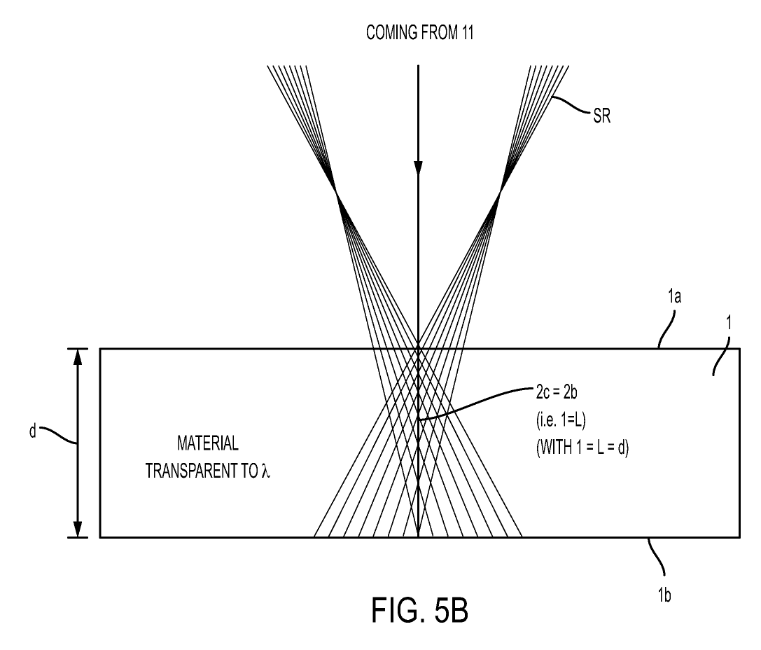

This is the reason for an enhanced optical assembly 6 which comprises both an axicon and a focusing lens. FIG. 5A depicts such an optical assembly 6 in which a first optical element (viewed along the beam direction) with a non-spherical free surface designed to form an extensive laser beam focal line 2b is positioned in the beam path of laser 3. In the case shown in FIG. 5A, this first optical element is an axicon 10 with a cone angle of 5°, which is positioned perpendicularly to the beam direction and centered on laser beam 3. The apex of the axicon is oriented towards the beam direction. A second, focusing optical element, here the plano-convex lens 11 (the curvature of which is oriented towards the axicon), is positioned in beam direction at a distance z1 from the axicon 10. The distance z1, in this case approximately 300 mm, is selected in such a way that the laser radiation formed by axicon 10 circularly incides on the marginal area of lens 11 (i.e., is incident in a circular or annular manner on the lens 11). Lens 11 focuses the circular radiation on the output side at a distance z2; in this case approximately 20 mm from lens 11, on a focal line 2b of a defined length, in this case 1.5 mm. The effective focal length of lens 11 is 25 mm here. The circular transformation of the laser beam by axicon 10 is labeled with the reference SR.

FIG. 5B depicts the formation of the focal line 2b or the induced absorption 2c in the material of substrate 1 according to FIG. 5A in detail. The optical characteristics of both elements 10, 11 as well as the positioning of them is selected in such a way that the extension 1 of the focal line 2b in beam direction is exactly identical with the thickness d of substrate 1. Consequently, an exact positioning of substrate 1 along the beam direction is required in order to position the focal line 2b exactly between the two surfaces 1a and 1b of substrate 1, as shown in FIG. 5B.

It is therefore advantageous if the focal line is formed at a certain distance from the laser optics, and if the greater part of the laser radiation is focused up to a desired end of the focal line. As described, this can be achieved by illuminating a primarily focusing element 11 (lens) only circularly on a required zone, which, on the one hand, serves to realize the required numerical aperture and thus the required spot size, on the other hand, however, the circle of diffusion diminishes in intensity after the required focal line 2b over a very short distance in the center of the spot, as a basically circular spot is formed. In this way, the crack formation is stopped within a short distance in the required substrate depth. A combination of axicon 10 and focusing lens 11 meets this requirement. The axicon acts in two different ways: due to the axicon 10, a usually round laser spot is sent to the focusing lens 11 in the form of a ring, and the asphericity of axicon 10 has the effect that a focal line is formed beyond the focal plane of the lens instead of a focal point in the focal plane. The length l of focal line 2b can be adjusted via the beam diameter on the axicon. The numerical aperture along the focal line, on the other hand, can be adjusted via the distance z1 axicon-lens and via the cone angle of the axicon. In this way, the entire laser energy can be concentrated in the focal line.

If the crack formation (i.e., defect line) is supposed to continue to the emergence side of the substrate, the circular illumination still has the advantage that, on the one hand, the laser power is used in the best possible way as a large part of the laser light remains concentrated in the required length of the focal line, on the other hand, it is possible to achieve a uniform spot size along the focal line—and thus a uniform separation process along the focal line—due to the circularly illuminated zone in conjunction with the desired aberration set by means of the other optical functions.

Instead of the plano-convex lens depicted in FIG. 5A, it is also possible to use a focusing meniscus lens or another higher corrected focusing lens (asphere, multi-lens system).

In order to generate very short focal lines 2b using the combination of an axicon and a lens depicted in FIG. 5A, it would be necessary to select a very small beam diameter of the laser beam inciding (or incident) on the axicon. This has the practical disadvantage that the centering of the beam onto the apex of the axicon must be very precise and that therefore the result is very sensitive to direction variations of the laser (beam drift stability). Furthermore, a tightly collimated laser beam is very divergent, i.e. due to the light deflection the beam bundle becomes blurred over short distances.

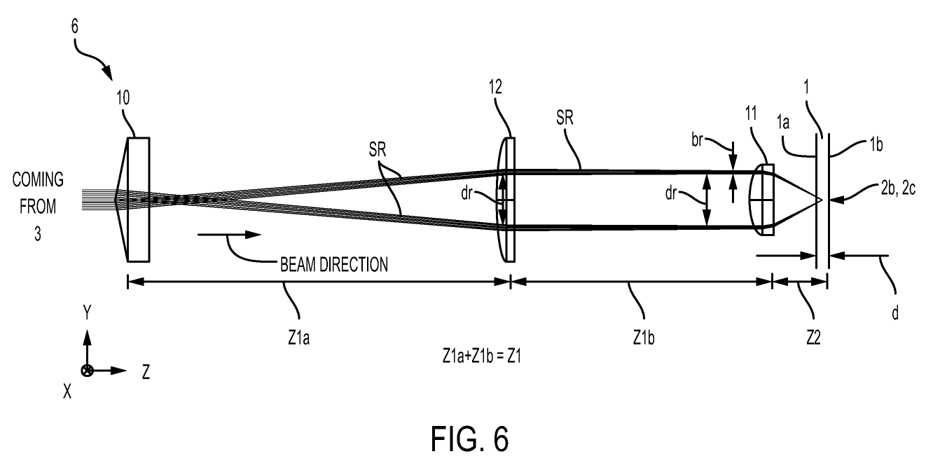

As shown in FIG. 6, both effects can be avoided by inserting another lens, a collimating lens 12: this further, positive lens 12 serves to adjust the circular illumination of focusing lens 11 very tightly. The focal length f of collimating lens 12 is selected in such a way that the desired circle diameter dr results from distance z1a from the axicon to the collimating lens 12, which is equal to f. The desired width br of the ring can be adjusted via the distance z1b (collimating lens 12 to focusing lens 11). As a matter of pure geometry, the small width of the circular illumination leads to a short focal line. A minimum can be achieved at distance f.

The optical assembly 6 depicted in FIG. 6 is thus based on the one depicted in FIG. 5A so that only the differences are described below. The collimating lens 12, here also designed as a plano-convex lens (with its curvature towards the beam direction) is additionally placed centrally in the beam path between axicon 10 (with its apex towards the beam direction), on the one side, and the plano-convex lens 11, on the other side. The distance of collimating lens 12 from axicon 10 is referred to as z1 a, the distance of focusing lens 11 from collimating lens 12 as z1b, and the distance of the generated focal line 2b from the focusing lens 11 as z2 (always viewed in beam direction). As shown in FIG. 6, the circular radiation SR formed by axicon 10, which incides (is incident) divergently and under the circle diameter dr on the collimating lens 12, is adjusted to the required circle width br along the distance z1b for an at least approximately constant circle diameter dr at the focusing lens 11. In the case shown, a very short focal line 2b is supposed to be generated so that the circle width br of approx. 4 mm at lens 12 is reduced to approx. 0.5 mm at lens 11 due to the focusing properties of lens 12 (circle diameter dr is 22 mm in the example).

In the depicted example it is possible to achieve a length of the focal line 1 of less than 0.5 mm using a typical laser beam diameter of 2 mm, a focusing lens 11 with a focal length f=25 mm, and a collimating lens with a focal length f=150 mm.

Furthermore applies Z1a=Z1b=140 mm and Z2=15 mm.

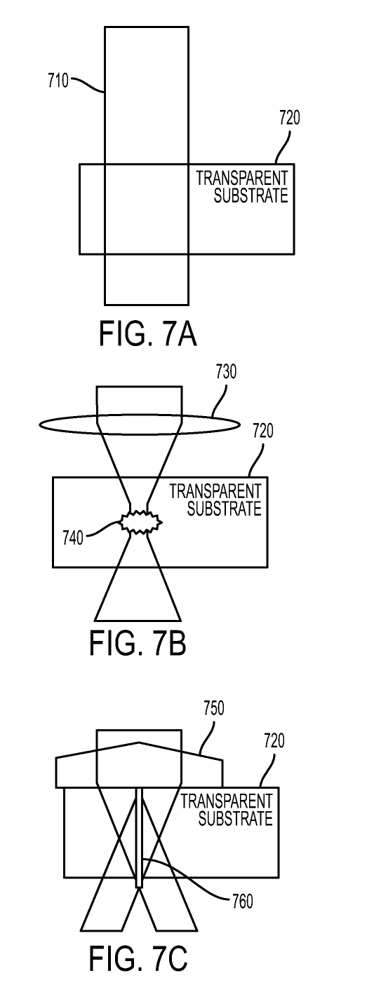

FIGS. 7A-7C illustrate the laser-matter interaction at different laser intensity regimes. In the first case, shown in FIG. 7A, the unfocused laser beam 710 goes through a transparent substrate 720 without introducing any modification to it. In this particular case, the nonlinear effect is not present because the laser energy density (or laser energy per unit area illuminated by the beam) is below the threshold necessary to induce nonlinear effects. The higher the energy density, the higher is the intensity of the electromagnetic field. Therefore, as shown in FIG. 7B when the laser beam is focused by spherical lens 730 to a smaller spot size, as shown in FIG. 7B, the illuminated area is reduced and the energy density increases, triggering the nonlinear effect that will modify the material to permit formation of a fault line only in the volume where that condition is satisfied. In this way, if the beam waist of the focused laser is positioned at the surface of the substrate, modification of the surface will occur. In contrast, if the beam waist of the focused laser is positioned below the surface of the substrate, nothing happens at the surface when the energy density is below the threshold of the nonlinear optical effect. But at the focus 740, positioned in the bulk of the substrate 720, the laser intensity is high enough to trigger multi-photon non-linear effects, thus inducing damage to the material. Finally, as shown in FIG. 7C in the case of an axicon, as shown in FIG. 7C, the diffraction pattern of an axicon lens 750, or alternatively a Fresnel axicon, creates interference that generates a Bessel-shaped intensity distribution (cylinder of high intensity 760) and only in that volume is the intensity high enough to create nonlinear absorption and modification to the material 720. The diameter of cylinder 760, in which Bessel-shaped intensity distribution is high enough to create nonlinear absorption and modification to the material, is also the spot diameter of the laser beam focal line, as referred to herein. Spot diameter D of a Bessel beam can be expressed as D=(2.4048 A)/(2rrB), where A is the laser beam wavelength and B is a function of the axicon angle.

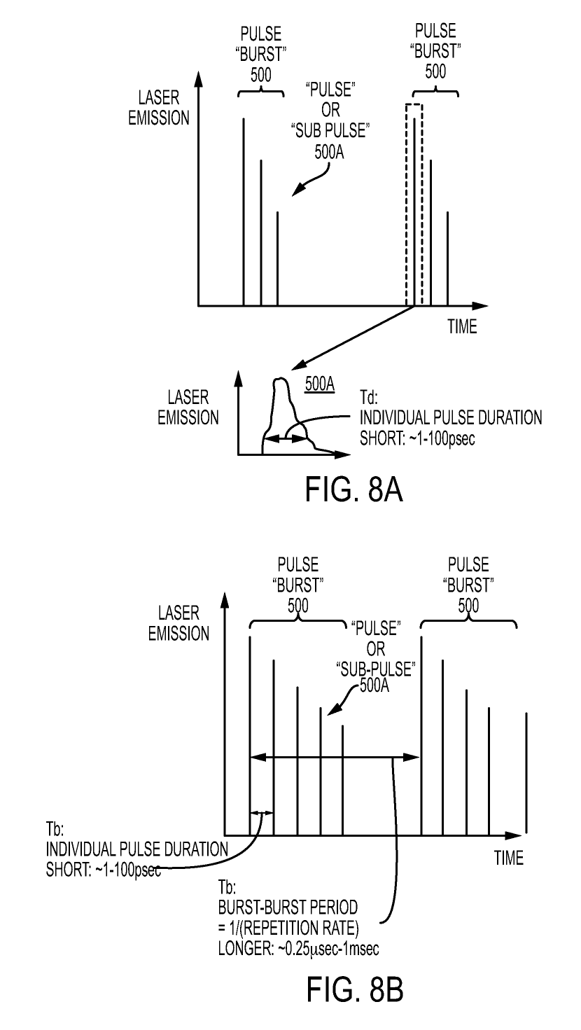

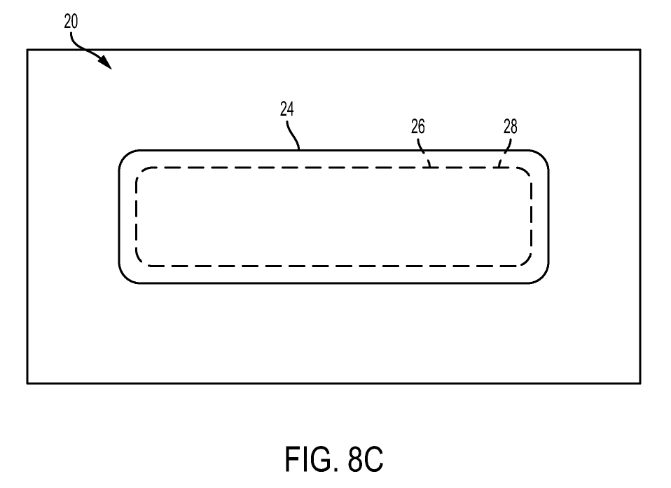

Note that typical operation of such a picosecond laser described herein creates a “burst” 500 of pulses 500A. (See, for example, FIGS. 8A and 8B). Each “burst” (also referred to herein as a “pulse burst” 500) contains multiple individual pulses 500A (such as at least 2 pulses, at least 3 pulses, at least 4 pulses, at least 5 pulses, at least 10 pulses, at least 15 pulses, at least 20 pulses, or more) of very short duration. That is, a pulse bust is a “pocket” of pulses, and the bursts are separated from one another by a longer duration than the separation of individual adjacent pulses within each burst. Pulses 500A have pulse duration T_{d} of up to 100 psec (for example, 0.1 psec, 5 psec, 10 psec, 15 psec, 18 psec, 20 psec, 22 psec, 25 psec, 30 psec, 50 psec, 75 psec, or therebetween). The energy or intensity of each individual pulse 500A within the burst may not be equal to that of other pulses within the burst, and the intensity distribution of the multiple pulses within a burst 500 often follows an exponential decay in time governed by the laser design. Preferably, each pulse 500A within the burst 500 of the exemplary embodiments described herein is separated in time from the subsequent pulse in the burst by a duration Tₚ from 1 nsec to 50 nsec (e.g. 10-50 nsec, or 10-30 nsec, with the time often governed by the laser cavity design). For a given laser, the time separation Tₚ between adjacent pulses (pulse-to-pulse separation) within a burst 500 is relatively uniform (±10%). For example, in some embodiments, each pulse within a burst is separated in time from the subsequent pulse by approximately 20 nsec (50 MHz). For example, for a laser that produces pulse separation Tₚ of about 20 nsec, the pulse to pulse separation Tₚ within a burst is maintained within about ±10%, or about ±2 nsec. The time between each “burst” of pulses (i.e., time separation T_{b} between bursts) will be much longer (e.g., 0.25≤T_{b}≤1000 microseconds, for example 1-10 microseconds, or 3-8 microseconds). In some of the exemplary embodiments of the laser described herein the time separation T_{b} is around 5 microseconds for a laser with pulse burst repetition rate or frequency of about 200 kHz. The laser burst repetition rate is relates to the time T_{b} between the first pulse in a burst to the first pulse in the subsequent burst (laser burst repetition rate=1/T_{b}). In some embodiments, the laser burst repetition frequency may be in a range of between about 1 kHz and about 4 MHz. More preferably, the laser burst repetition rates can be, for example, in a range of between about 10 kHz and 650 kHz. The time T_{b} between the first pulse in each burst to the first pulse in the subsequent burst may be 0.25 microsecond (4 MHz burst repetition rate) to 1000 microseconds (1 kHz burst repetition rate), for example 0.5 microseconds (2 MHz burst repetition rate) to 40 microseconds (25 kHz burst repetition rate), or 2 microseconds (500 kHz burst repetition rate) to 20 microseconds (50k Hz burst repetition rate). The exact timings, pulse durations, and burst repetition rates can vary depending on the laser design, but short pulses (T_{d}<20 psec and preferably T_{d}≤15 psec) of high intensity have been shown to work particularly well.

The energy required to modify the material can be described in terms of the burst energy—the energy contained within a burst (each burst 500 contains a series of pulses 500A), or in terms of the energy contained within a single laser pulse (many of which may comprise a burst). For these applications, the energy per burst can be from 25-750 μJ, more preferably 50-500 μJ, or 50-250 μJ. In some embodiments the energy per burst is 100-250 μJ. The energy of an individual pulse within the pulse burst will be less, and the exact individual laser pulse energy will depend on the number of pulses 500A within the pulse burst 500 and the rate of decay (e.g., exponential decay rate) of the laser pulses with time as shown in FIGS. 8A and 8B. For example, for a constant energy/burst, if a pulse burst contains 10 individual laser pulses 500A, then each individual laser pulse 500A will contain less energy than if the same pulse burst 500 had only 2 individual laser pulses.

The use of a laser capable of generating such pulse bursts is advantageous for cutting or modifying transparent materials, for example glass. In contrast with the use of single pulses spaced apart in time by the repetition rate of the single-pulsed laser, the use of a pulse burst sequence that spreads the laser energy over a rapid sequence of pulses within the burst 500 allows access to larger timescales of high intensity interaction with the material than is possible with single-pulse lasers. While a single-pulse can be expanded in time, as this is done the intensity within the pulse must drop as roughly one over the pulse width. Hence if a 10 psec single pulse is expanded to a 10 nsec pulse, the intensity drop by roughly three orders of magnitude. Such a reduction can reduce the optical intensity to the point where non-linear absorption is no longer significant, and light material interaction is no longer strong enough to allow for cutting. In contrast, with a pulse burst laser, the intensity during each pulse 500A within the burst 500 can remain very high—for example three 10 psec pulses 500A spaced apart in time by approximately 10 nsec still allows the intensity within each pulse to be approximately three times higher than that of a single 10 psec pulse, while the laser is allowed to interact with the material over a timescale that is now three orders of magnitude larger. This adjustment of multiple pulses 500A within a burst thus allows manipulation of time-scale of the laser-material interaction in ways that can facilitate greater or lesser light interaction with a pre-existing plasma plume, greater or lesser light-material interaction with atoms and molecules that have been pre-excited by an initial or previous laser pulse, and greater or lesser heating effects within the material that can promote the controlled growth of microcracks. The required amount of burst energy to modify the material will depend on the substrate material composition and the length of the line focus used to interact with the substrate. The longer the interaction region, the more the energy is spread out, and higher burst energy will be required. The exact timings, pulse durations, and burst repetition rates can vary depending on the laser design, but short pulses (<15 psec, or ≤10 psec) of high intensity have been shown to work well with this technique. A defect line or a hole is formed in the material when a single burst of pulses strikes essentially the same location on the glass. That is, multiple laser pulses within a single burst correspond to a single defect line or a hole location in the glass. Of course, since the glass is translated (for example by a constantly moving stage) (or the beam is moved relative to the glass, the individual pulses within the burst cannot be at exactly the same spatial location on the glass. However, they are well within 1 μm of one another—i. e., they strike the glass at essentially the same location. For example, they may strike the glass at a spacing, sp, from one another where 0<sp≤500 nm. For example, when a glass location is hit with a burst of 20 pulses the individual pulses within the burst strike the glass within 250 nm of each other. Thus, in some embodiments 1 nm<sp<250 nm. In some embodiments 1 nm<sp<100 nm.

Multi-photon effects or multi-photon absorption (MPA) is the simultaneous absorption of two or more photons of identical or different frequencies in order to excite a molecule from one state (usually the ground state) to a higher energy electronic state (ionization). The energy difference between the involved lower and upper states of the molecule can be equal to the sum of the energies of the two photons. MPA, also called induced absorption, can be a second-order, third-order process, or higher-order process, for example that is several orders of magnitude weaker than linear absorption. MPA differs from linear absorption in that the strength of induced absorption can be proportional to the square or cube (or higher power law) of the light intensity, for example, instead of being proportional to the light intensity itself. Thus, MPA is a nonlinear optical process.

The lateral spacing (pitch) between the defect lines (damage tracks) is determined by the pulse rate of the laser as the substrate is translated underneath the focused laser beam. Only a single picosecond laser pulse burst is usually necessary to form an entire hole, but multiple bursts may be used if desired. To form damage tracks (defect lines) at different pitches, the laser can be triggered to fire at longer or shorter intervals. For cutting operations, the laser triggering generally is synchronized with the stage driven motion of the workpiece beneath the beam, so laser pulse bursts are triggered at a fixed spacing, such as for example every 1 micron, or every 5 microns. Distance, or periodicity, between adjacent perforations or defect lines along the direction of the fault line can be greater than 0.1 micron and less than or equal to about 20 microns in some embodiments, for example. For example, the spacing or periodicity between adjacent perforations or defect lines is between 0.5 and 15 microns, or between 3 and 10 microns, or between 0.5 micron and 3.0 microns. For example, in some embodiments the periodicity can be between 2 micron and 8 microns.

We discovered that using pulse burst lasers with certain volumetric pulse energy density (μJ/μm²) within the approximately cylindrical volume of the line focus re preferable to create the perforated contours in the glass. This can be achieved, for example, by utilizing pulse burst lasers, preferably with at least 2 pulses per burst and providing volumetric energy densities within the alkaline earth boro-aluminosilicate glasses (with low or no alkali) of about 0.005 μJ/μm³ or higher to ensure a damage track is formed, but less than 0.100 μJ/μm³ so as to not damage the glass too much, for example 0.005 μJ/μm³-0.100 μJ/μm³

### Interior Contour Process

FIG. 1 illustrates the problem to be solved. A part 22 is to be cut out of a glass sheet 20 that forms a portion of a consumer device 1000. However, interior holes or slot(s) 22 s are “locked in place”, and is difficult to remove. Even if the glass is high stress and crack propagate from perforation to perforation in the outer diameter of the hole or slot, the interior glass will not release, as the material will be too rigid and is held by compressional force.

FIG. 8C illustrates a process that solves this problem, and has been successfully used to separate holes down to 1.5 mm diameter out of 0.7 mm thick code 5318 glass (ion-exchanged), and also to create slots. Step 1—A perforation of a first contour 24 is made in glass sheet 20 using the picosecond pulse burst process that defines the desired shape of the contour (e.g., hole, slot) to be cut. For example, in some embodiments 150 μJ-260 μJ pulses were utilized to perforate the material and to create damage tracks or defect lines at 6-10 μm pitch. Depending on the exact material, other damage track spacings may also be employed, such as 1-15 microns, or 3-10 microns, or 3-7 microns. For ion-exchangeable glasses such as those described above, 3-7 micron pitch works well, but for other glasses such smaller pitches may be preferred, such as 1-3 microns. In the embodiments described herein, typical pulse burst laser powers are 10 W-150 Watts with laser powers of 25-60 Watts being sufficient (and optimum) for many glasses. In one exemplary embodiment the glass is a 0.7 mm ion exchanged glass substrate, the picosecond laser is a 200 kHz, 48 W (240 μJ pulse energy) laser, the pitch (defect line spacing) is about 8 μm, and the length of the focal line is 2.2 mm.

Step 2—Now that the two pieces of glass are physically distinct, the central portion of glass (plug) can be removed in a variety of ways. The primary goal is to limit the thermal damage to underlying components of the device 1000. This can be done via laser processing by choosing a sufficient wavelength such that the laser is highly absorbed by the glass substrate 20 (e.g., 1/e absorption depth <10 microns). This can also be done by choosing a laser pulse duration that is sufficiently short (<50 nanoseconds) to limit thermal damage. In this example, a highly focused CO₂ laser 28 is focused to a spot and is used to ablate the material inside the hole, by tracing out the approximate path situated slightly to the interior of the perforation contour described above (e.g., about (50 to 300 microns, e.g., 100 μm, 150 or 200 microns) inside the contour).

The processing of glass by the laser 28 will physically melt, ablate, and drive out the glass material inside of the hole or slot. For example, if the glass is code 2320 0.7 mm thick ion exchanged glass or 5318 (0.8 mm thick) available from Corning Incorporated, a CO₂ laser power of about 14 Watts with a focused spot size of about 100 μm diameter can be used, and the CO₂ laser is translated around the path at a speed of about 0.35 m/min, executing 5-15 passes to completely remove the material within a annular trench surrounding the glass plug, the number of passes begin dependent on the thickness of the glass and the exact geometry of the hole or slot. Because of the primary goal of reducing thermal damage to underlying components, the exact number of passes must be optimized for a given glass using either sacrificial proxies or through an iterative approach. In general, for this process step, the CO₂ beam would be defined as “focused” if it achieved a high enough intensity such that the glass material is ablated by the high intensity. For example, the power density of the focused spot can be about 1750 W/mm², which would be accomplished with the above described conditions, or could be from 500 W/mm² to 5000 W/mm², depending on the desired speed of traversal of the laser beam across the surface.

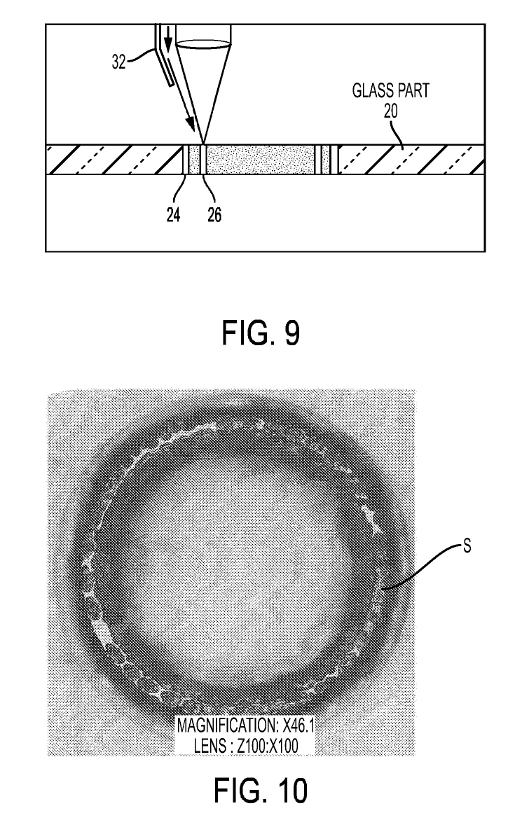

FIG. 9 shows a side view of the above this process, to illustrate how the CO₂ ablation.

### Sample Results:

FIG. 10 shows the results of the process, for a cover glass for a typical handheld phone. The geometry of the hole was about 5.0 mm. More specifically, FIG. 10 shows a top view microscope image of the glass showing the hole formation after using a Bessel beam (pulsed first laser beam formed into a laser beam focal line) on chemically strengthened (in this embodiment ion exchanged) cover glass. The laser beam focal line (in this embodiment a focal line formed by the Bessel beam) “traced” a closed inner contour defining an inner glass piece and generated an induced absorption within the glass, forming multiple perforations (nano-sized perforations) to create the closed inner contour. (The faint circle shown in FIG. 10 is exterior to the CO₂ laser damage is the 5 mm diameter circle defining the closed inner contour—i.e., it is exterior region of the glass surrounding the ablated glass region). At least a portion of the inner glass piece situated within the inner contour was then ablated using a focused (CO₂) laser beam of laser 28. For example, this ablated portion may be annular region surrounding solid central glass plug. The glass plug is easily removed by applying a vacuum suction to the plug, or even by applying an adhesive tape to the surface of the glass plug and then lifting the plug out of the surrounding glass.

The function of the nanoperforation contour is to contain damage that is caused by the ablation process. The nanoperforations will stop, deflect, or arrest cracks that are formed in the interior plug, and prevent them from propagating out into the exterior region of the cover glass.

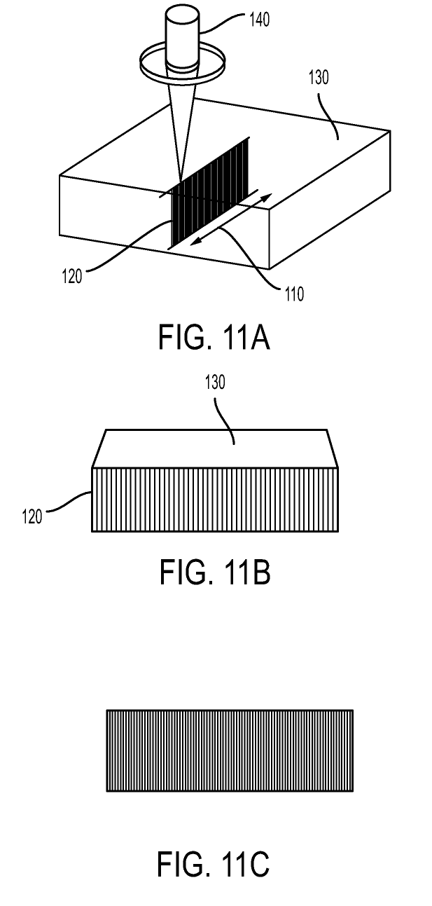

As illustrated in FIGS. 11A-11C, the method to cut and separate transparent materials, and more specifically chemically strengthen (e.g., ion exchanged) glass compositions, is essentially based on creating a fault line 110 formed of a plurality of vertical defect lines 120 in the material or workpiece 130 to be processed with an ultra-short pulsed laser 140. The defect lines 120 extend, for example, through the thickness of the glass sheet, and are orthogonal to the major (flat) surfaces of the glass sheet. “Fault lines” are also referred to as “contours” herein. While fault lines or contours (or their portions) can be linear, like the fault line 110 illustrated in FIG. 11A, the fault lines or contours can also be nonlinear, having a curvature. Curved fault lines or contours can be produced by translating either the workpiece 130 or laser beam 140 with respect to the other in two dimensions instead of one dimension, for example. As illustrated in FIG. 11A, a plurality of defect lines can define a contour. The separated edge or surface with the defect lines is defined by the contour. The induced absorption creating the defect lines can produce particles on the separated edge or surface with an average diameter of less than 3 microns, resulting in a very clean cutting process.

Distance, or periodicity, between adjacent defect lines 120 along the direction of the fault lines 110 can be greater than 0.1 micron and less than or equal to about 20 microns in some embodiments, for example. For example, in some embodiments, the periodicity between adjacent defect lines 120 may be between 0.5 and 15 microns, or between 3 and 10 microns, or between 0.5 micron and 3.0 microns. For example, in some embodiments the periodicity between adjacent defect lines 120 can be between 0.5 micron and 1.0 micron.

There are several methods to create the defect line. The optical method of forming the line focus can take multiple forms, using donut shaped laser beams and spherical lenses, axicon lenses, diffractive elements, or other methods to form the linear region of high intensity. The type of laser (picosecond, femtosecond, etc.) and wavelength (IR, green, UV, etc.) can also be varied, as long as sufficient optical intensities are reached to create breakdown of the substrate material in the region of focus to create breakdown of the substrate material or glass workpiece, through nonlinear optical effects. Preferably, the laser is a pulse burst laser which allows for control of the energy deposition with time by adjusting the number of pulses within a given burst.

In the present application, an ultra-short pulsed laser is used to create a high aspect ratio vertical defect line in a consistent, controllable and repeatable manner. The details of the optical setup that enables the creation of this vertical defect line are described below, and in U.S. Application No. 61/752,489 filed on Jan. 15, 2013, the entire contents of which are incorporated by reference as if fully set forth herein. The essence of this concept is to use optics to create a line focus of a high intensity laser beam within a transparent part. One version of this concept is to use an axicon lens element in an optical lens assembly to create a region of high aspect ratio, taper-free microchannels using ultra-short (picoseconds or femtosecond duration) Bessel beams. In other words, the axicon condenses the laser beam into a high intensity region of cylindrical shape and high aspect ratio (long length and small diameter). Due to the high intensity created with the condensed laser beam, nonlinear interaction of the electromagnetic field of the laser and the substrate material occurs and the laser energy is transferred to the substrate to effect formation of defects that become constituents of the fault line. However, it is important to realize that in the areas of the material where the laser energy intensity is not high (e.g., glass volume of substrate surrounding the central convergence line), the material is transparent to the laser and there is no mechanism for transferring energy from the laser to the material. As a result, nothing happens to the glass or workpiece when the laser intensity is below the nonlinear threshold.

The methods described above provide the following benefits that may translate to enhanced laser processing capabilities and cost savings and thus lower cost manufacturing. The cutting process offers:

1) Full separation of interior contours being cut: the methods described above are capable of completely separating/cutting holes and slots in a clean and controlled fashion in ion-exchangeable glass (such as Gorilla® glass, Corning glass codes 2318, 2319, 2320 or the like) as produced by the fusion draw process, or other glass forming processes, before the glass part has undergone chemical strengthening.

2) Creation of holes/slots with limited thermal damage to the surrounding glass. The process disclosed here has been used to remove glass plugs that have, for example, 5 mm diameter dimensions in 0.8 mm thick cover glass in a consumer electronic devices s without damaging underlying structures or components.

3) Forming of holes or slots in the cover glass of the fully functional consumer electronic device, while leaving the rest of exterior cover glass intact.

### Cutting Complex Profiles and Shapes in Different Sizes

The methods described above enable cutting/separation of glass and other substrates following many forms and shapes, which is a limitation in other competing technologies. Tight radii may be cut (<2 mm), allowing creation of small holes and slots (such as required for speakers/microphone in a cell phone application). Also, since the defect lines strongly control the location of any crack propagation, those method give great control to the spatial location of a cut, and allow for cut and separation of structures and features as small as a few hundred microns.

Thus, according to some embodiments, a glass article has at least one inner contour edge with plurality of defect lines extending perpendicular to the face of the glass sheet at least 250 μm, the defect lines each having a diameter less than or equal to about 5 μm. For example, a glass article has at least one inner contour edge having a plurality of defect lines extending perpendicular to the major (i.e., large relative to the sides) flat face of the glass sheet at least 250 μm, the defect lines each having a diameter less than or equal to about 5 μm. In some embodiments, the smallest dimension or width of the interior contour defined by the inner contour edge is less than 5 mm, for example it may be 0.1 mm to 3 mm in width (or diameter), e.g., 0.5 mm to 2 mm. According to some embodiments, the glass article comprises post-ion exchange glass. According to some embodiments, the defect lines extend the full thickness of the at least one inner contour edge. According to at least some embodiments, the at least one inner contour edge has an Ra surface roughness less than about 0.5 μm. According to at least some embodiments, the at least one inner contour edge has subsurface damage up to a depth less than or equal to about 75 μm. In at least some embodiments, of the glass article the defect lines extend the full thickness of the edge. The distance between the defect lines is, for example, less than or equal to about 7 μm.

Additional embodiments are described in paragraphs A through Z6, below:
A. According to some embodiments a method of forming a glass article, comprises:
   I. focusing a pulsed first laser beam into a laser beam focal line;
   II. directing the laser beam focal line into an ion exchanged glass substrate at a plurality of locations along a closed inner contour defining an inner glass piece, the laser beam focal line generating an induced absorption within the ion exchanged glass substrate such that the laser beam focal line produces a defect line extending through a thickness of the ion exchanged glass substrate at each location of the plurality of locations;
   III. directing another focused laser beam into at least a portion of the inner glass piece and ablating at least the least a portion of the inner glass piece.
B. The method according to A, further comprising removing of the inner glass piece from the ion exchanged glass substrate.
C. The method according to A or B, wherein said another focused laser beam is directed to an inner perimeter of the closed inner contour.
D. The method according any of the paragraphs A-C, wherein the closed inner contour is a circle.
E. The method according to D, further comprising removing of glass material of the inner glass piece from the ion exchanged glass substrate.
F. The method according A-E, wherein the ion exchanged glass substrate is a cover glass mounted in a consumer electronic device.
G. The method according to F, wherein the ion exchanged glass substrate is situated over an electronic component of the consumer electronic device and the pulsed first laser beam has a wavelength that is transparent to the ion exchanged glass substrate but not to the electronic component.
H. The method according to F or G, wherein the ion exchanged glass substrate is situated on top of another glass.
I. The method according to H, wherein the focal line does not generate induced absorption within the other glass.
J. The method according to A, wherein the ion exchanged glass substrate is situated at least partially over display glass.
K. The method according to J, wherein the focal line does not generate induced absorption within the display glass.
L. The method according to A-F, wherein the ion exchanged glass substrate is situated at least partially over of electronic components, and the focal line does not damage the electronic components.
M. The method according A-L, wherein laser beam focal line does not generate induced absorption within the electronic components.
N. The method according Paragraphs A-M, said another laser beam is a Gaussian laser beam
O. The method according to any of the paragraphs A-F, the ion exchanged glass substrate is situated at least partially over another device component said wherein the focusing pulsed first laser beam has a wavelength that is greater than 1.2 microns or is smaller than 380 nm.
The method according to any of the claims A-F or O, the ion exchanged glass substrate is situated at least partially over another device component, and the laser beam focal line does not extend into said another device component.
Q1. The method according to any of the paragraphs A-F wherein
(i) the ion exchanged glass substrate is a cover glass mounted in an consumer electronic device; and
(ii) the ion exchanged glass substrate is situated at least partially over another component of the consumer electronic device: and
(iii) said another focused laser beam that oblates the glass has a wavelength that is strongly absorbed by the glass of the ion exchanged glass substrate, but not strongly absorbed by the another component.
Q2. The method of Q1, wherein the ion exchanged glass substrate is situated at least partially over a display glass and at least partially over at least one electronic component, the method further comprising a step of removing of the inner glass piece from the ion exchanged glass substrate, without damaging the cover glass or said at least one electronic component.
Q3. The method of Q1 or Q2, wherein said another focused laser beam has at least one of: (a) wavelength that non-transparent to the housing of said at least one electronic component;
(b) has a single pulse frequency ≤50 ns.
Q4. The method of Q3, wherein the wavelength that is non-transparent to the housing of said at least one electronic component is either greater than 1.2 microns or is smaller than 380 nm.
Q5. The method of paragraph Q1 or Q2, wherein said another focused laser beam is produced by a picosecond laser.
R1. The method according to any of the paragraphs A-F, wherein step III comprises tracing an infrared laser beam over the closed inner contour.
R2. The method according to R1, wherein a wavelength of the infrared third laser beam is in a range from about 9 micrometers to about 11 micrometers.
R3. The method according to R2, wherein the infrared third laser beam is a CO₂ laser beam.
S. The method according to paragraph A, wherein
(i) the ion exchanged glass substrate is a cover glass mounted in an consumer electronic device; and
(ii) the ion exchanged glass substrate is situated at least partially over: (a) a display glass of the consumer electronic device, and (b) at least partially over an electronic component of the consumer electronic device; and
(c) wherein the focusing pulsed first laser beam has a wavelength; and
(d) wherein said electronic component has a housing containing material that absorbs light in said wavelength; and the absorptive material is situated between said at least one electronic component under the hole absorbs the line focus wavelength.
T. The method according to paragraph A, wherein
(i) the ion exchanged glass substrate is a cover glass mounted in an consumer electronic device; and
(ii) the ion exchanged glass substrate is situated at least partially over: (a) a display glass of the consumer electronic device, and (b) at least partially over an electronic component of the consumer electronic device; and the closed inner contour defining the inner glass piece is not situated over the display glass, and is situated over the electronic component.
U. The method according paragraph A, wherein the ion exchanged glass substrate is a cover glass mounted in a consumer electronic device; the cover glass having a bezel area and the closed inner contour defining the inner glass piece situated inside the bezel area.
V. A method of laser drilling an ion exchanged material comprising:
focusing a pulsed laser beam into a laser beam focal line, viewed along the beam propagation direction;
directing the laser beam focal line into the ion exchanged material at a first location, the laser beam focal line generating an induced absorption within the material, the induced absorption producing a damage track along the laser beam focal line within the material;
translating the material and the pulsed laser beam relative to each other starting from the first location along a first closed contour, thereby laser drilling a plurality of holes along the first closed contour within the material; and
directing a focused laser into the material around a second closed contour contained within the first closed contour to facilitate removal of an inner plug of the material along the first closed contour.
W. The method of V, wherein the second closed contour is offset from the first closed contour by less than 500 μm.
X. The method according to claim V or W wherein the focused laser directed into the material around a second closed contour contained within the first closed contour is a CO₂ laser.
Y. A method of laser drilling an ion exchanged material comprising:
focusing a pulsed laser beam into a laser beam focal line, viewed along the beam propagation direction;
directing the laser beam focal line into the ion exchanged material at a first location, the laser beam focal line generating an induced absorption within the material, the induced absorption producing a damage track along the laser beam focal line within the material;
translating the material and the pulsed laser beam relative to each other starting from the first location along a first closed contour, thereby laser drilling a plurality of holes along the first closed contour within the material; and
directing a focused laser into the material around a second closed contour contained within the first closed contour to facilitate removal of an inner plug of the material along the first closed contour.
Z. The method of Y, wherein the material has a thickness in a range of between about 100 μm and about 8 mm.

The relevant teachings of all patents, published applications and references cited herein are incorporated by reference in their entirety.

While exemplary embodiments have been disclosed herein, it will be understood by those skilled in the art that various changes in form and details may be made therein without departing from the scope of the invention encompassed by the appended claims.

What is claimed is:

1. A method of forming a glass article, comprising:
I. focusing a pulsed first laser beam into a laser beam focal line;
II. directing the laser beam focal line into an ion exchanged glass substrate at a plurality of locations along a closed inner contour defining an inner glass piece, the laser beam focal line generating an induced absorption within the ion exchanged glass substrate such that the laser beam focal line produces a defect line extending through a thickness of the ion exchanged glass substrate at each location of the plurality of locations;
III. directing another focused laser beam into at least a portion of the inner glass piece and ablating at least the least a portion of the inner glass piece.

2. The method according to claim 1, further comprising removing of the inner glass piece from the ion exchanged glass substrate.

3. The method according to claim 1, wherein the focused laser beam is directed to an inner perimeter of the closed inner contour.

4. The method according to claim 1, wherein the closed inner contour is a circle.

5. The method according to claim 4 further comprising removing of glass material of the inner glass piece from the ion exchanged glass substrate.

6. The method according to claim 1, wherein the ion exchanged glass substrate is a cover glass mounted in a consumer electronic device.

7. The method according to claim 6, wherein the ion exchanged glass substrate is situated over an electronic component of the display device and the pulsed first laser beam has a wavelength that is transparent to the ion exchanged glass substrate but not to the electronic component.

8. The method according to claim 6 wherein the ion exchanged glass substrate is situated on top of another glass.

9. The method according to claim 8, wherein the focal line does not generate induced absorption within the other glass.

10. The method according to claim 1, wherein the ion exchanged glass substrate is situated at least partially over of display glass.

11. The method according to claim 10, wherein the focal line does not generate induced absorption within the display glass.

12. The method according to claim 1, wherein the ion exchanged glass substrate is situated at least partially over of electronic components, and the focal line does not damage the electronic components.

13. The method according to claim 1, wherein laser beam focal line does not generate induced absorption within the electronic components.

14. The method according to claim 1, said other laser beam is a Gaussian laser beam

15. The method according to claim 1, the ion exchanged glass substrate is situated at least partially over another device component said wherein the focusing pulsed first laser beam has a wavelength that is greater than 1.2 microns or is smaller than 380 nm.

16. The method according to claim 1, the ion exchanged glass substrate is situated at least partially over another device component, and the laser beam focal line does not extend into said another device component.

17. The method according to claim 1, wherein
(iv) the ion exchanged glass substrate is a cover glass mounted in an consumer electronic device; and
(v) the ion exchanged glass substrate is situated at least partially over another component of the consumer electronic device: and
(vi) said another focused laser beam that oblates the glass has a wavelength that is strongly absorbed by the glass of the ion exchanged glass substrate, but not strongly absorbed by the another component.

18. The method of claim 17, wherein the ion exchanged glass substrate is situated at least partially over a display glass and at least partially over at least one electronic component, the method further comprising a step of removing of the inner glass piece from the ion exchanged glass substrate, without damaging the cover glass or said at least one electronic component.

19. The method of claim 18, wherein said another focused laser beam has at least one of: (a) wavelength that non-transparent to the housing of said at least one electronic component;
(e) has a single pulse frequency ≤50 ns.

20. The method of claim 19, wherein the wavelength that is non-transparent to the housing of said at least one electronic component is either greater than 1.2 microns or is smaller than 380 nm.

21. The method of claim 18, wherein said another focused laser beam is produced by a picosecond laser.

22. The method according to claim 1, wherein step III comprises tracing an infrared laser beam over the closed inner contour.

23. The method according to claim 22, wherein a wavelength of the infrared third laser beam is in a range from about 9 micrometers to about 11 micrometers.

24. The method according to claim 23, wherein the infrared third laser beam is a CO₂ laser beam.

25. The method according to claim 1, wherein
(iii) the ion exchanged glass substrate is a cover glass mounted in an consumer electronic device; and
(iv) the ion exchanged glass substrate is situated at least partially over: (a) a display glass of the consumer electronic device, and (b) at least partially over an electronic component of the consumer electronic device; and
(f) wherein the focusing pulsed first laser beam has a wavelength; and
(g) wherein said electronic component has a housing containing material that absorbs said wavelength; and the absorptive material is situated between said at least one electronic component under the hole absorbs the line focus wavelength.

26. The method according to claim 1, wherein
(iii) the ion exchanged glass substrate is a cover glass mounted in an consumer electronic device; and
(iv) the ion exchanged glass substrate is situated at least partially over: (a) a display glass of the consumer electronic device, and (b) at least partially over an electronic component of the consumer electronic device; and the closed inner contour defining the inner glass piece is not situated over the display glass, and is situated over the electronic component.

27. The method according to claim 1, wherein
the ion exchanged glass substrate is a cover glass mounted in an consumer electronic device; the cover glass having a bezel area and the closed inner contour defining the inner glass piece situated inside the bezel area

28. A method of laser drilling an ion exchanged material comprising:
focusing a pulsed laser beam into a laser beam focal line, viewed along the beam propagation direction;
directing the laser beam focal line into the ion exchanged material at a first location, the laser beam focal line generating an induced absorption within the material, the induced absorption producing a damage track along the laser beam focal line within the material;
translating the material and the pulsed laser beam relative to each other starting from the first location along a first closed contour, thereby laser drilling a plurality of holes along the first closed contour within the material; and
directing a focused laser into the material around a second closed contour contained within the first closed contour to facilitate removal of an inner plug of the material along the first closed contour.

29. The method of claim 28, wherein the second closed contour is offset from the first closed contour by less than 500 μm.

30. The method according to claim 28, wherein the focused a focused laser directed into the material around a second closed contour contained within the first closed contour is a CO₂ laser.

31. A method of laser drilling an ion exchanged material comprising:
focusing a pulsed laser beam into a laser beam focal line, viewed along the beam propagation direction;
directing the laser beam focal line into the ion exchanged material at a first location, the laser beam focal line generating an induced absorption within the material, the induced absorption producing a damage track along the laser beam focal line within the material;
translating the material and the pulsed laser beam relative to each other starting from the first location along a first closed contour, thereby laser drilling
a plurality of holes along the first closed contour within the material; and directing a focused laser into the material around a second closed contour contained within the first closed contour to facilitate removal of an inner plug of the material along the first closed contour.

32. The method of claim 30, wherein the material has a thickness in a range of between about 100 μm and about 8 mm.
